(19) United States
(12) Patent Application Publication
(10) Pub. No.: US 2003/0126611 A1
(43) Pub. Date: Jul. 3, 2003

(54) Methods and apparatus for controlling interactive television information and commerce services

(75) Inventors: Richard S. Chernock, Newtown, CT (US); Paolo Dettori, Elmsford, NY (US); James Lipscomb, Yorktown Heights, NY (US); Lurng-Kuo Liu, White Plains, NY (US); Jurij R. Paraszczak, Pleasantville, NY (US); Frank A. Schaffa, Hartsdale, NY (US); David I. Seidman, Bronx, NY (US); Liang-Jie Zhang, Cortland Manor, NY (US)

Correspondence Address: Ryan, Mason & Lewis, LLP, 90 Forest Avenue, Locust Valley, NY, 11560, US

(73) Assignee: International Business Machines Corporation, Armonk, NY

(21) Appl. No.: 10/034,222

(22) Filed: Dec. 28, 2001

(51) Int. Cl. H04N 7/173; H04N 7/16

(52) U.S. Cl. 725/105; 725/86; 725/139; 725/117

(57) ABSTRACT

An apparatus is provided for an interactive television commerce environment, acting as a central point of control and information for enabling and facilitating information distribution and transactions in this environment. The apparatus is an essential element of an interactive television (ITV) commerce system, and enables the introduction of interactive commerce services in cable, satellite, and other broadcast networks. Other services provided include interfacing with off-line interactive ads, historical review and tracking services for users, and providing feedback and ITV ad modification capabilities to advertisers. The apparatus, residing at a local head end, can also add to or modify ads by inserting content of local relevance.

### FIELD OF THE INVENTION

The present invention relates generally to interactive television, and more specifically, to methods and apparatus for controlling interactive television information and commerce services.

### BACKGROUND OF THE INVENTION

Television production, mass media, and Internet technology companies are turning their attention to the emerging medium of interactive television (ITV). ITV uses technologies, typically from the Internet, to deliver interactive content in the form of graphical and informational elements on the same screen as a video program. Once transmitted over the air or via telephone wires and cables, the interactive content is televised in coordination with video programming viewed on traditional TV sets, computers, and on other video-ready digital products.

To the end user or viewer, the interactive content appears as audio or graphical and informational images on the screen accompanying a video broadcast. Often these images are opaque and cover the video broadcast in part, or they are transparent or semi-transparent. Specific reoccurring interactive content images include icons, banners, labels, menus, information about the program, data one can print, text, or forms to fill out in order to buy a product. If the producer has done an adequate job, the interactive content will be relevant to the television programming presented with it.

To navigate and participate in such interactive television broadcasts, viewers can use the buttons on the remote control, type commands or words with a wireless keyboard on certain systems, or use the mouse if viewing ITV via a computer with a TV tuner card. The viewer's responses to the interactive content are transferred by the set-top box as signals back to the broadcast station. Where the viewer's set-top box is connected to the broadcaster over a cable TV network, the viewer's response signals are returned over a duplex communication path of the cable TV network. Where the viewer's set-top box is connected to the broadcaster over a wireless link, the viewer's response signals can be returned over a duplex communication path of the wireless link or alternately they may be returned via another medium, such as the public switched telephone network.

In order for network operators, such as cable TV multi-service operators (MSOs), to offer interactive services to their subscribers, a large investment is necessary in the information technology (IT) and transactional infrastructure, which enables and tracks transactions on their networks. Without this infrastructure, which is often prohibitively costly, network operators cannot currently enter the market.

In addition, conventional controllers are not designed to be retrofit into an existing network (such as a cable network) on which transactions are taking place. Conventional controllers typically require significant re-engineering of clients, servers, and the way they transact business.

Accordingly, there is a need for a central system element for controlling interactive television information and commerce services.

### SUMMARY OF THE INVENTION

The present invention provides a controller for the coordination of interactive television offerings over a transaction-enabled broadcast network. The controller is a processor that is operative to receive broadcast content from a broadcast source, process the broadcast content, transmit the processed broadcast over the network to a viewer, receive data over the network from the viewer, the data being transmitted by the viewer in response to the processed broadcast content, and processing the data received from the viewer. The controller performs various functions in processing the broadcast content and/or the data received from the viewer in response to receiving the broadcast content.

Advantageously, the controller of the invention acts as a central system element for transaction-enabled broadcast networks, such as terrestrial, cable or satellite television networks, to serve as a central point of control and information regarding interactivity on these networks. Such a device allows network operators to keep track of money spent in network transactions that take place over their networks between clients and servers. Such a device also permits the network operator to offer e-commerce services without requiring them to own the entire IT and transactional infrastructure.

In processing broadcast content, the controller can, for example, manage, add to, or modify the broadcast content. For example, the controller can add interactive content to an advertisement that was not originally an interactive ad. The processor can also redirect network traffic to the appropriate server for local fulfillment of goods and services which are advertised in broadcast ads, and which are purchased through interactivity with those ads. In processing data received from the viewer, the controller can, for example, tabulate purchasing history information, store credit card and ship-to information of the viewer, and verify the identification of the viewer. The controller can also be operatively configured to tabulate commerce transactions occurring over the network.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating the components of a controller in accordance with the present invention.

FIG. 2 is a flow diagram depicting the steps performed by a controller of the present invention.

FIG. 3 is a block diagram illustrating a system that includes a controller in accordance with the present invention.

FIG. 4 is a block diagram illustrating functions of a controller in accordance with the present invention.

### DETAILED DESCRIPTION OF PREFERRED EMBODIMENTS

An exemplary controller is presented which is suitable for use as a central point of control and information for enabling and facilitating interactive content distribution and transactions in an ITV commerce environment. The controller is an essential element of an ITV commerce system, and enables the introduction of interactive commerce over a transaction-enabled broadcast network. Examples of broadcast networks include cable, satellite, and terrestrial networks.

ITV as used herein means broadcast content, such as programming and advertising, that includes interactive content. Interactive content enables a viewer to conduct commerce over a transaction-enabled broadcast network. A viewer as defined herein is a receiver of broadcast content.

Commerce can include, for example, an offer for sale of a product or service. Commerce can also include, for example, a viewer requesting further information, e.g., about a product or service, or making a transaction, such as a purchase of a product. Products can include not only physical items, but also digital items, such as music files, software, etc. A transaction-enabled broadcast network is a television broadcast network upon which commerce can be conducted electronically between the viewer and a server.

The controller of the invention offers a low-cost solution for the introduction of these services in broadcast networks, in contrast with alternative systems, which involve the redesign of the network's IT infrastructure. The controller of the invention is designed to be retrofit into an existing network.

ITV commerce services are implemented using data inserted into the broadcast channel (i.e., on the “downstream” side) and a return channel such as a phone line attached to the viewer's receiving device (i.e., on the “upstream” side). Without a controller of the invention being included in the network, commerce which is transacted on the network can go untracked by the network operator. This may result in lost revenues, because operators may receive a fraction of the proceeds of these transactions. Thus, the controller provides a critical service for operators by monitoring the extent and dollar amount of transactions. Also, by intermediating between users and commerce servers, the controller can be a source of valuable statistical information on viewing habits, buying patterns, etc., while ensuring that the privacy and security of users' information is safeguarded.

Other controller services presented include providing a service for interfacing with off-line interactive ads, historical review of commerce transactions and tracking services for users, and providing feedback and ITV ad modification capabilities to advertisers. The controller can also add to or modify broadcast ads by inserting content of local relevance.

FIG. 1 is a block diagram illustrating a controller 100 in accordance with the present invention. The controller 100 includes input/output (I/O) device(s) 102, a processor 104, a memory 106 and interface(s) 108, all connected to communicate over a system bus 110.

Elements or groups of elements of the controller 100 may represent corresponding elements of an otherwise conventional desktop computer, as well as portions or combinations of these and other processing devices. Moreover, in other embodiments of the invention, some or all of the functions of the processor 104 or other elements of the controller 100 may be combined into a single device. For example, one or more of the elements of the controller 100 may be implemented as an application specific integrated circuit (ASIC) or line card to be incorporated into a computer or other processing device.

The term “processor” as used herein is intended to include a microprocessor, central processing unit, or any other data processing element that may be utilized in a given data processing device to perform one or more or the functions described herein. In addition, it should be noted that the memory 106 may represent an electronic memory, an optical or magnetic disk-based memory, a tape-based memory, as well as combinations or portions of these and other types of storage devices. For example, memory 106 may represent an electronic memory of a computer or other processing device and includes the associated drives such as a CD ROM drive and a floppy disk drive.

The I/O device(s) 102 can include, for example, one or more input devices (e.g., keyboard, mouse, etc.) for entering or altering data or software in the controller 100. The I/O device(s) 102 can also include one or more output devices, for example, video monitor, printer, etc.

The interface(s) 108 can include any conventional network interface. For example, a local area network (LAN) interface card can be used to support, e.g., an Ethernet port. In general, interface(s) 108 provides communication interfaces to any system components with which the controller 100 of the invention is operatively coupled.

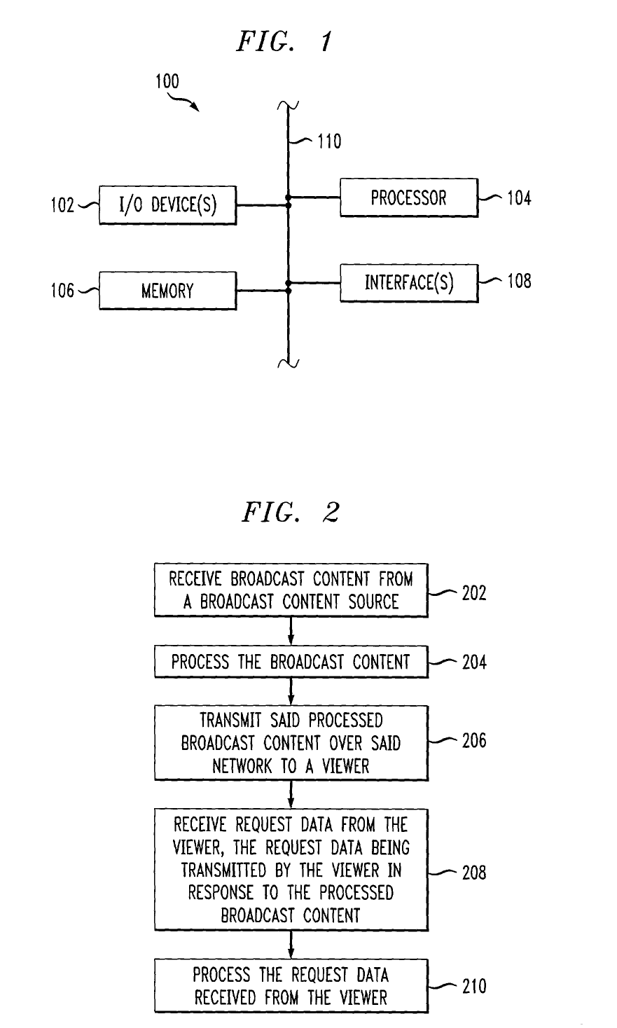

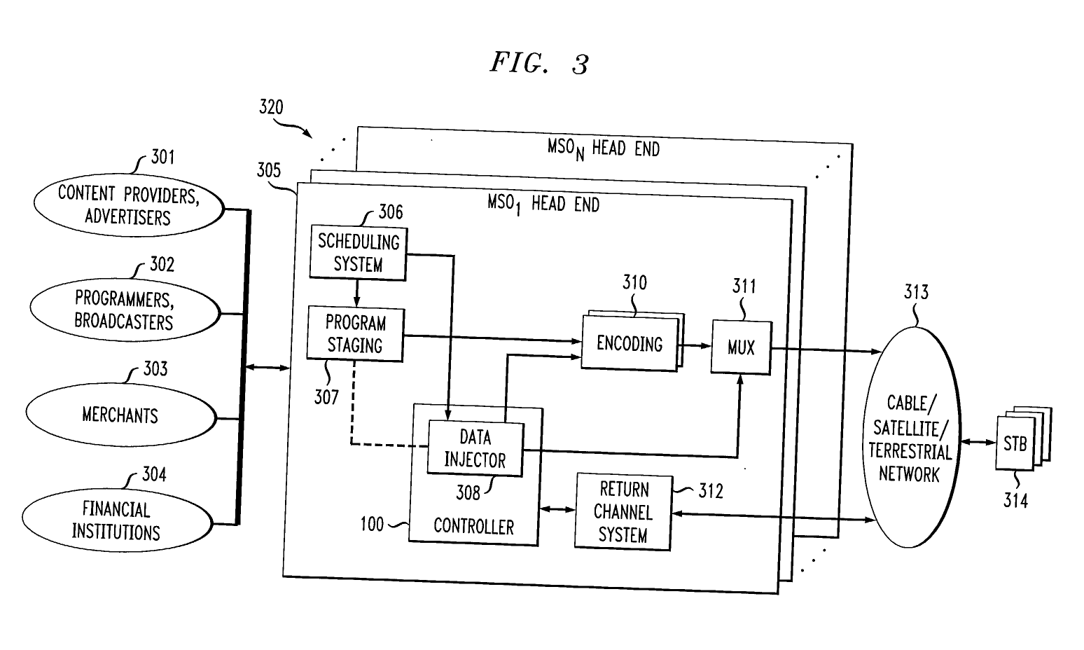

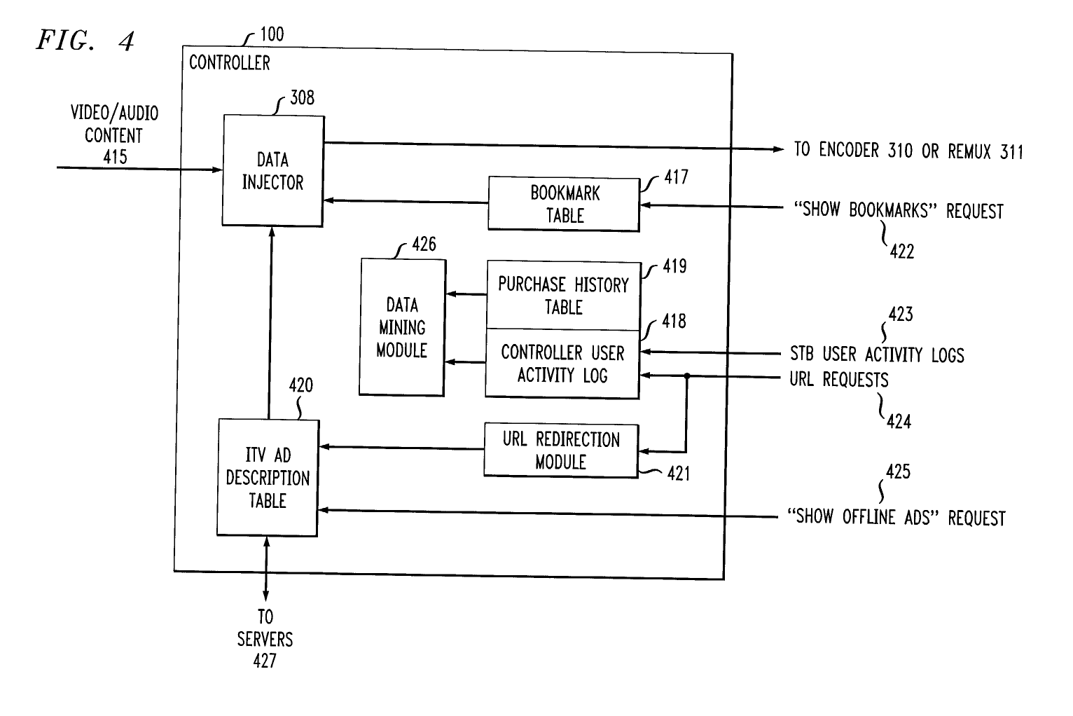

FIG. 2 is a flow diagram illustrating the basic steps performed by a controller of the invention. In step 202, broadcast content is received from a broadcast content source. In step 204, the broadcast content is processed. Processing step 204 is more particularly described below with regard to FIGS. 3 and 4 and the various functions that the controller 100 of the invention provides. In step 206, the processed broadcast is transmitted over the network to a viewer. In step 208, the controller receives request data from a viewer. The request data is transmitted by the viewer in response to receiving the processed broadcast content. In step 210, the request data from the viewer is processed by the controller 100. This processing step 210 is also more fully described below with regard to FIGS. 3 and 4 and the various functions performed by the controller.

The invention can also be implemented at least in part in the form of one or more software programs which are stored on an electronic, magnetic or optical storage medium and executed by a processing device.

FIG. 3 illustrates a transaction-enabled broadcast network system 320 in accordance with the present invention. As shown, the system 320 includes a multi-service operator (MSO) 305, such as a local cable operator; entities providing broadcast content, such as content providers and advertisers 301 and programmers and broadcasters 302; a broadcast receiving device, such as a set-top box 314; a network 313; return channel system 312; scheduling system 306; program staging device 307; controller 100; data injector 308; encoder 310; and multiplexer (mux) 311.

At least one controller 100 resides at a multi-service operator (MSO) 305, such as a local cable operator. The MSO 305 is also referred to herein as a “network operator.” Video/audio content arrives at the MSO 305 from a variety of sources, which can include, for example, content providers and advertisers 301 and programmers and broadcasters 302. A scheduling system 306, preferably residing at the MSO 305, determines which ads or programs are to be broadcast. Such ads or programs are staged by a program staging module 307 also included at the MSO 305. The program staging module 307 also communicates with the data injector 308 to coordinate the timing of the injected data into the broadcast stream.

When the controller 100 is adding interactive content, it does so using a data injector 308. The controller 100 then interfaces with an encoder 310, which may be external to the controller, to digitize the video/audio content. Once encoded, the processed broadcast content is multiplexed by a multiplexer (or mux) 311 in preparation for broadcast over a network 313. If the added content is already in the proper format for broadcast, the data can be forwarded directly from the data injector 308 to the mux 311 without having to be encoded by the encoder 310. When the broadcast content arriving at the MSO 305 already contains interactive content, for example, when the interactive content is provided directly by a programmer or broadcaster 302, the processing of the broadcast content by the controller 100 may simply involve the transmission of the content to the viewer.

The broadcast content is received by a broadcast receiving device 314, e.g. a set-top box (STB) at the viewer's end. The receiving device is operative to receive video, audio, and interactive content. An application running on the receiving device's processor extracts the broadcast content, displays it, and handles the interactive offering and response by the user.

In response to receiving the interactive content, data may be sent from the viewer via the receiving device 314 back through the network 313 to the MSO 305. This data is referred to herein as request data. Request data can include, for example, a request for additional information concerning an interactive ad or a request to make a purchase. The request data is sent from the viewer's receiving device 314 to the controller 100 by a return channel system 312. If the network 313 is a two-way network, such as a cable network, the return channel system may simply include an interface at the MSO 305 for receiving the data. If a two-way network is not provided (not shown), the return channel system 312 may further include a network, such as a phone line or cable, attached to the receiving device 314. If the viewer wishes to make a purchase, the data from the viewer may be forwarded from the MSO 305 to a merchant 303 to supply the item and/or a financial institution 304 to coordinate payment. The request data is processed at the controller 100 which identifies the viewer from whom the request was sent, and performs a variety other functions more fully described below.

FIG. 4 illustrates various functions that may be performed by each controller 100 in accordance with the present invention. The controller 100 as shown in FIG. 4 includes a data injector 308, bookmark table 417, controller user activity log 418, purchase history table 419, data mining module 426, ITV ad descriptor table 420, and URL redirection module 421.

As shown in FIG. 4, data from viewers can include, for example, a request to display the bookmarks which the viewer (or his/her equipment) has set 422, a request to display purchase opportunities not currently broadcast (i.e. “Off-line” purchase opportunities) or ads 425, or a request to access a universal resource locator (URL) 424.

A bookmark is a record of a viewer's interest in an interactive offering. The record can be initiated, for example, by the viewer, viewer's equipment, or the controller 100. Placement of a bookmark for an interactive offering allows the viewer to rapidly return to the offering at a later time.

A request to access a URL 424 is handled by a URL redirection module 421 of the controller 100, which redirects the URLs requests and forwards them to servers for local fulfillment, thus intermediating between viewers and servers. Local fulfillment means fulfillment by a local merchant or server of a viewer's commercial or informational request. A URL request may also be redirected to relieve a server of network congestion.

URL requests are also sent for parsing and record-keeping to the controller user activity log 418 and the purchase history table 419. STB user activity logs 423 which arrive from viewers' STBs can also be input into the controller user activity log 418. The data mining module 426 coupled to the controller user activity log 418 and the purchase history table 419 utilizes the records in the stored log and table to determine, for example, patterns of interactivity, viewer preferences (subject to the consent of the viewer), and purchasing trends, and is used to generate transaction reports. Requests for bookmark display 422 utilizes the bookmark table 417.

The controller 100 preferably includes an ITV ad descriptor table 420 which includes detailed information regarding the interactive ads which are being broadcast. The ITV ad descriptor table 420 is coupled to the URL redirection module 421 for redirecting received URL requests to servers 427. The ITV ad descriptor table 420 also receives the request to display off-line ads 425.

The controller 100 platform can be a PC running a run-time application engine, such as the WebSphere Application Server (from IBM Corporation), and a relational database, such as DB2 (UDB) (from IBM Corporation). Software objects handling sessions and providing database connectivity are used to implement the controller component functions. One option for interfacing with the STB 314 is to use a Web/Proxy Server and Java Server Pages generating XML (Extensible Markup Language) or HTML (HyperText Markup Language) content.

One issue in the airing of ITV ads and program content is the overlap of viewer interaction with one ad and the airing of subsequent ads. Advertisers who pay high rates for their ads to be aired do not want viewers who are still interacting with the previous ad to miss their content. Thus, in one preferred embodiment of the present invention, the controller schedules only one ITV ad per “pod” (i.e. a group of commercials), and the ITV ad is placed last in the pod, as advertisers typically do not mind if interactivity overlaps with a program's content.

STB applications for ITV commerce often use a modified browser. Many commercially available browsers can be modified for the STB environment. In one preferred embodiment of the present invention, the interface for user interaction with ITV content is simply the existing remote control. In one preferred embodiment of the present invention, credit card and address information for the viewer are pre-stored at the controller. This is important for security reasons, and because most viewers will not have an alphabetic remote control keyboard at their service. Several “ship to” addresses can be pre-stored at the controller for each viewer, during service setup, and the viewer selects one of them at the time of purchase.

In a preferred embodiment, the controller 100 also functions to verify the identity of the viewer. Each viewer responding to the interactive content may be assigned a personal identification number (PIN). For the sake of simplicity, it is preferred that only one PIN per broadcast receiving device 314 be used, regardless of the number of people in the household who may be using the device.

In one preferred embodiment of the present invention, the controller 100 collects stored data from the broadcast receiving device 314 during hours of low network load, e.g. 3 A.M. This data can be stored at the controller 100 in a user activity log 418. Alternatively, this data can be stored at the STB, which avoids having to contact the controller 100 to report each key pressed by each viewer thereby preventing undue loads on the network 313.

The system 320 and controller 100 as described above provide a number of unique functions. These functions include:

collecting data on interactions prior to, or not leading to a purchase;

offering feedback to advertisers and broadcasters on the effectiveness of ads;

offering network operators cumulative information on purchases;

offering users historical review of purchases;

offering users the ability to track purchases made on various servers;

serving as a collector (and presenter) of previously-broadcast interactive ads (“off-line purchasing”);

modifying characteristics of ads (such as the timing of interactivity); and

adding or modifying the content of a nationally broadcast ad with local information.

Exemplary functions of the controller 100 are further described below and can be categorized as follows:

1. Broadcast Services

a. Adding Interactivity to non-ITV Content

b. Enabling Interactivity for ITV Content

c. Adding Local Content

2. Online Services

a. Purchasing and other Transactions

b. Traffic Shaping

3. Off-line Services

a. Purchasing

b. Bookmarking

4. Post-Purchase Services

a. Network Transaction Reports

b. User Purchase History Review

c. User Purchase Tracking

d. Data Mining

e. Advertiser Statistical Reporting

f. Advertiser ITV Ad Parameter Adjustment

The functions provided by the controller 100 are described more fully below.

1. Broadcast Services

As seen in FIG. 3, at least one controller 100 resides at an MSO 305 which broadcasts programs and advertisements over a network 313, for example, cable, satellite, or terrestrial broadcast. Content is provided by, for example, content providers and advertisers 301 as well as programmers and broadcasters 302. Advertisements and/or programs can be enriched with data for interactive content prior to broadcast, using an authoring toolset for specifying the content, timing, and other parameters of interactivity.

The enriched advertisement is broadcast from the MSO 305 and the data is extracted by an application running on the broadcast receiving device, e.g. STB 314. The STB 314 renders, for the viewer, graphics offering interactive services. If desired, the viewer can interact with the STB 314 using, for example, a remote control interface and the telephone or other return channel system 312, to retrieve information, transact purchases, and perform other functions. Data which is not available in the broadcast stream can be delivered via the non-broadcast (or “return”) channel 312, such as a phone line or cable modem which is attached to the STB 314.

a. Adding Interactivity to Non-ITV Content

Ads or programs which are not originally created for interactivity (i.e. simple video/audio content) are made interactive by the controller 100. An authoring toolset such as IBM HotMediaTV™ can be used to enrich the video/audio content of the program or advertisement, to add interactive data to it. Clearly, the advertiser or program sponsor must agree to have their content enhanced in this way, and business methods are provided herein to cover this situation. The advertiser would contract with the network operator to have their ads enhanced with interactive content for a given time period.

One advantage to this method versus creating a fixed-content interactive ad is that the added content can change over time. For example, an advertiser who is running a limited time sale can have the interactive content reflect this time limit, and then go back to airing the basic interactive content when the sale has expired. The controller 100 would receive the unenhanced ad from the content provider or advertiser and inject data into the broadcast stream at the time the ad was scheduled.

b. Enabling Interactivity for ITV Content

The network operator typically only carries in the broadcast signal the content that must by carried by law. This content, such as closed captioning information for the hearing-impaired, is called the “must carry” signal. For the operator to carry the interactive content as well, advertisers must pay a higher price. Thus, method of conducting e-commerce over a transaction-enable network is provided that includes the addition of interactive content for a specific time period, whether that content is added by the advertiser, content provider, or the controller 100 itself.

When the time period for carrying the interactive content has lapsed, the operator must be able to drop the interactive content from the broadcast. The controller 100 performs this function, having been programmed to know when the period of interactivity has ended. Similarly, an ad with interactive content may begin airing before the start of the period of interactivity, and the controller 100 can play this ad, dropping the interactive content until this period begins.

c. Adding Local Content

As ads may arrive at an MSO 305 from a national or regional broadcaster, advertisers may want the capability to give viewers locally-specific information, such as the address or phone number of the local franchise of a national chain of stores. The controller 100, residing at the MSO 305, and typically knowing the location of each subscriber is in a unique position to provide this service.

The controller 100 adds text, audio or graphics to an advertiser's content giving the viewer the local information. The placement or timing of the interactive content can be performed so as to not be obtrusive to the ad's content. Optionally, an additional level of “localization” can be provided by the controller 100 working with the STB 314 application. Several local information items can be added to the broadcast stream by the controller 100, and the receiving device can be configurable to filter out information irrelevant to the viewer. For example, addresses of several retailers can be added to the broadcast ad for a chain, to be displayed as on-screen text superimposed over the video at the last 10 seconds of a 60-second ad. Each address can be accompanied by a range of zip codes which are near that franchise. The STB 314, knowing the viewer's zip code, can reference this information and display the address of the franchise which is closest to the viewer. This local content can, of course, be interactive as well.

2. Online Services

a. Purchasing and Other Transactions

In the online purchasing scenario, an interactive TV advertisement is created by a content creator, typically the same entity which created the audio and video content. Alternatively, the interactive content may be added to a broadcast program by the controller 100. The enriched content (audio, video, and interactive data) is broadcast and received by the client's STB 314, which is running an application to detect and extract this data. Examples of interactive data include URLs, text describing purchase-able items, graphics such as icons, and “metadata,” which is data that describes the data which has been added to the broadcast. The advertisement may be broadcast nationally or locally.

Additionally, the controller 100 and STB 314 application customize the interactive content which is seen by the viewer by embedding multiple types of content (e.g. icons for different products) in the broadcast. The content is either identified with an address for a specific viewer or viewer group, or identified generally (with keywords, for example) and filtered by the application. In this case, a viewer interest profile is stored either at the controller 100 or the STB 314.

Prior to the broadcast, based on business agreements, the controller 100 can be prepared for the broadcast. “Redirect URLs” are specified and stored in the controller 100 in order to map the URL from the broadcast ad to the appropriate local server. When the user interacts with the advertisement, typically by pressing a key on the remote control and using the telephone line for a return channel, the controller 100 recognizes the advertisement by use of a unique ad identifier and maps it to a local server.

The viewer's STB 314, running an application which detects the presence of data in the broadcast stream, extracts the data from the stream. An initial indication of interactivity, either text or graphics, is superimposed by the STB 314 application on the television screen. The graphic image may be extracted from the broadcast stream, or its URL may be indicated in the stream and the image retrieved via the return channel.

Once a viewer shows interest by interacting with the on-screen indication, subsequent text and graphics are retrieved via the return channel 312. The viewer may interact to get more information about the product or program, or choose to make a purchase.

When a viewer requests a purchase, the transaction is handled by a server, for example, a merchant's server, similarly to any Internet transaction, but with the distinction that the controller 100 resides in the path between the client (here the STB 314) and the server. The URL requested by the viewer's STB 314 application is evaluated by the controller. The controller 100 performs re-mapping by using redirect URLs, which are pre-stored on the controller 100, based on the STB identifier and the ad identifier. The controller 100 thus directs traffic which is generated by a single nationally broadcast ad, for example, to any number of local servers for fulfillment of the transaction.

The controller 100 maintains a record of all significant user activity. In addition to recording how the user interacted with the ITV ad or program generally, the monetary value of transactions taking place are recorded.

The controller 100 analyzes the raw data into usable and valuable statistics for the cable or service operator. All transaction data is reported to a centralized database, which can be used in the aggregate by such network operators and others. Smaller cable operators can also use this data for targeting to local subscribers. Owning this data provides an important source of service revenue for the network operator, and reduces customer calls regarding purchases to the cable operators' customer service centers. One valuable use of this information is in the measurement of the effectiveness of an ad campaign.

b. Traffic Shaping

The nature of interactive television, offering opportunities for interactivity at specific times to large broadcast audiences, results in the synchronization of potentially high degrees of demand on servers. As opposed to the Internet, where items of data on a Web page are made available at any time, the ITV system 320 of necessity consolidates the requests for items to short periods of time following a prompt, such as an onscreen “buy this” icon or text message.

Because the controller 100 intermediates on all viewer/server traffic in this environment, it has the capability of routing each request to one of a multiplicity of servers. Thus, the traffic into and out of any server can be shaped and server flooding and crashing may be avoided. The processor 104 within the controller 100 is configurable to determine network or server load. When an ITV data item is available on multiple servers, judicious use of traffic shaping can send traffic to unoccupied servers and relieve other servers. In the case of multiple servers residing in different time zones, the controller 100 takes advantage of the idleness of some servers in their “off” times, i.e. times of low network load.

3. Off-line Services

a. Off-line Purchasing

At any time, the client may request to view a “channel” of purchase opportunities. This may be in response to an interactive ad which the viewer saw but did not interact with, or for items which the viewer did not see. The controller 100 maintains a database of all current interactive ads and displays the icons related to these ads to the viewer. The controller 100 may be informed of the schedules for the airing of these ads, in order to display primarily or exclusively those ads which have aired recently, and thus may have been missed by the viewer who has requested to perform an off-line purchase. Alternatively, the controller 100 can display ads irrespective of their schedule, as long as the items in the ads are still available.

Ads can be characterized by a number of keywords, and these keywords are used to display the purchase opportunities in categories such as Food, Sports, Clothes, etc. Once the client has selected the icon for a product in which he/she is interested, purchasing proceeds as in the Online Purchasing case.

b. Bookmarking

Purchases are also made by a viewer off-line by the viewer first saving interactive content of interest, such as an advertisement, as a bookmark. The controller 100 can then compile the content in a bookmark table 417. The viewer can then revisit the interactive material at any time by entering the bookmark and choosing the material of interest.

4. Post-Purchase Services

a. Network Transaction Reports

One of the most critical functions that can be performed by the controller 100 is reporting to the network operator concerning the amount and extent of commercial transactions which are handled on the network. This function enables the operator to share in the profits of these transactions, with an accurate figure for the moneys involved. Network Transaction Reports can be generated for the operator by the controller 100.

To ensure the privacy of the viewer, the operator does not receive any information regarding the sum of purchases transacted for any one viewer or household. Beyond the total price of the transaction, which is always made available to the operator in the report, the degree of additional information available to the operator is dependent on the agreement of the viewer, as specified at setup.

Reports can be made in the aggregate, but broken down into categories to inform the operator about purchasing patterns. Categories in the Network Transaction Report can include:

number of purchases by time of purchase;

purchase amounts by time of purchase;

number of purchases by cost of item;

number of purchases by age range of viewer;

purchase amounts by age range of viewer;

number of purchases by type of program/advertisement;

purchase amounts by type of program/advertisement.

These breakdowns can be helpful to operators and advertisers in positioning their future ITV offerings for best effect.

b. User Purchase History Review

At any time, the client may request a review of the purchase activity of his/her entire household or by individual in the household. The controller 100 maintains records for all clients' purchases in the database, and responds with a display of all purchases for this client which were transacted over this network.

The display can include for each purchase, for example, name of item, merchant, time of purchase, cost of item, quantity of items, total cost, shipping method, and confirmation number.

c. User Purchase Tracking

The client may also request the status of a given purchase. The controller 100 then assists in the tracking of a purchase, based on a confirmation number which it maintains for each purchase, and the purchase tracking mechanisms available for the item. Since the confirmation number is known to the controller 100, and many shipping services offer tracking services, the controller 100 responds to a viewer's tracking request by extracting status information from the shipper's web site.

d. Data Mining

The controller 100 also enables the network operator to track and review all purchases which have been transacted through the operator's system. Knowing the purchasing history of a user or group of users, the controller 100 acts as a source for the targeted distribution of content. The controller 100 is thus a central information point in a complex commerce transaction network, a point of control, a source of information on network transactions, and a source of services revenue.

In addition to the statistics shown above, data mining can be used to address the following questions:

1) Was a given advertisement (or in-program prompt) effective in generating user interactivity?

2) Was a given advertisement (or in-program prompt) effective in generating subsequent purchases?

3) For viewers not completing a purchase, how many ITV screens were shown before the viewer ended the interaction?

4) What type of items are most likely to be purchased via ITV?

5) What type of items are least likely to be purchased via ITV?

6) Items of what dollar amount are most and least likely to be purchased via ITV?

7) How many purchases, on average, can an ITV-friendly viewer be expected to make in a month?

8) Do purchasers fall into categories of heavy and light purchasers?

9) What is the demographic of an ITV-friendly viewer?

e. Advertiser Statistical Reporting

Advertisers who sponsor ITV ads (whether the interactive data was added by them, a content provider, or the controller 100) wish to know how effective these ads are in generating viewer interest and purchases. The controller 100 offers the network operator the capability to give this and other feedback to advertisers. Using their experience in one airing of an ad, or one ad campaign, advertisers can modify their ITV ad offerings through the controller 100 to attract more interest.

f. Advertiser ITV Ad Parameter Adjustment

Some parameters of ITV ads may be modified from one airing of an ad to another. These parameters can include, for example, size of graphic icons, number of graphic icons, screen placement of graphic icons, use of graphic icons vs. text notifications, and use of audio tones.

Since the controller 100 may control the interactive data which is added to the broadcast, it is possible for the controller 100 to offer, as a service to advertisers, the capability to modify these parameters. For example, if reports indicate a poor response for ITV ads in which icons were placed near the top of the screen, the controller 100 accommodates a request from the advertiser that the icons be placed differently in subsequent airings of the ad.

Although illustrative embodiments of the present invention have been described herein, it is to be understood that the invention is not limited to those precise embodiments, and that various other changes and modifications can be made by one skilled in the art without departing from the scope or spirit of the invention.

What is claimed is:

1. An apparatus for controlling interactive television offerings over a transaction-enabled broadcast network, the apparatus comprising:
at least one processor operative to: (i) receive broadcast content from a broadcast content source; (ii) process the broadcast content; (iii) transmit said processed broadcast content over said network to a viewer; (iv) receive request data over said network from said viewer, said data being transmitted by said viewer in response to said processed broadcast content; and (v) process said request data; wherein said processor is further operative as a central point of control for said request data or interactive content contained within said broadcast content; and
memory, operatively coupled to the processor, for storing at least a portion of data related to at least one of the receiving, transmitting and processing steps.

2. The apparatus of claim 1 wherein said broadcast content from a broadcast source comprises advertising content.

3. The apparatus of claim 1 wherein said broadcast content from a broadcast source comprises program content.

4. The apparatus of claim 1 wherein said processor is further operative to add interactive content to the broadcast content.

5. The apparatus of claim 4 wherein said added interactive content is advertising content.

6. The apparatus of claim 5 wherein said advertising content is added at the end of a group of commercials.

7. The apparatus of claim 1 wherein said processor is further operative to collect and store previously broadcast content.

8. The apparatus of claim 7 wherein said previously broadcast content comprises advertisement content.

9. The apparatus of claim 7 wherein said previously broadcast content comprises interactive content.

10. The apparatus of claim 7 wherein said previously broadcast content is accessible by said viewer in conducting e-commerce.

11. The apparatus of claim 4 wherein said added interactive content specifies local purchasing information.

12. The apparatus of claim 1 wherein said broadcast content from a broadcast content source comprises interactive content.

13. The apparatus of claim 12 wherein said processor is further operative to modify said interactive content.

14. The apparatus of claim 13 wherein said modification of interactive content is performed by an advertiser.

15. The apparatus of claim 13 wherein said modification of interactive content is performed by a network operator.

16. The apparatus of claim 12 wherein said processor is further operative to selectively enable or disable said interactive content.

17. The apparatus of claim 1 wherein said request data comprises a universal resource locator (URL) and wherein said processor is further operative to redirect said URL.

18. The apparatus of claim 17 wherein said redirecting a URL further comprises reducing network congestion.

19. The apparatus of claim 17 wherein said redirecting a URL further comprises forwarding said URL to a local server for fulfillment.

20. The apparatus of claim 1 wherein said memory is operative to store data based on commerce conducted by the viewer over said network.

21. The apparatus of claim 20 wherein said processor is further operative to formulate a table of viewer purchasing history data based on said stored data.

22. The apparatus of claim 20 wherein said data based on commerce conducted by the viewer over said network is collected from a broadcast receiving device of said viewer.

23. The apparatus of 22 wherein said broadcast receiving device comprises a set-top box.

24. The apparatus of claim 20 wherein said processor is further operative to collect said data based on commerce conducted by the viewer during a period of low network load.

25. The apparatus of claim 20 wherein said stored data is accessible to said viewer over said network.

26. The apparatus of claim 20 wherein said stored data is accessible to a network operator.

27. The apparatus of claim 20 wherein said stored data is accessible to an advertiser.

28. The apparatus of claim 1 wherein said processor is further operative to associate a personal identification number with the viewer.

29. The apparatus of claim 28 wherein a unique personal identification number is associated with an individual viewer.

30. The apparatus of claim 28 wherein a unique personal identification number is associated with a particular broadcast receiving device.

31. The apparatus of claim 1 wherein said processor is further operative to securely store credit card information of said viewer.

32. The apparatus of claim 1 wherein said processor is further operative to store at least one ship-to address of said viewer.

33. A system for conducting e-commerce over a transaction-enabled broadcast network, said system comprising:
a broadcast receiving device operatively coupled to said network and configurable to enable a viewer to interact with an interactive broadcast; and
a local network operator operatively coupled to said network, said local network operator comprising a controller, said controller being operatively configurable to tabulate commerce transactions occurring over said network.

34. A system for conducting e-commerce over a transaction-enabled broadcast network, said system comprising:
a broadcast receiving device operatively coupled to said network and configurable to enable a viewer to interact with a broadcast comprising interactive content; and
a local network operator operatively coupled to said network, said local network operator comprising a controller, said controller operatively configurable to selectively modify, enable or disable said interactive content.

35. A system for conducting e-commerce over a transaction-enabled broadcast network, said system comprising:
a broadcast receiving device operatively coupled to said network and configurable to enable a viewer to interact with an interactive broadcast; and
a local network operator operatively coupled to said network, said local network operator comprising a controller, said controller operatively configurable to add interactive content to non-interactive broadcast content.

36. The system of claim 35 wherein said controller is further operative to route request data from said viewer in response to said interactive broadcast to a server for fulfillment.

37. The system of claim 36 wherein said server is a local server.

38. The system of claim 35 wherein said broadcast content comprises multiple interactive content streams and wherein said broadcast receiving device is operative to filter said multiple interactive content streams.

39. The system of claim 38 wherein said filtering of multiple interactive content streams is based at least in part on the relevance of said interactive content streams to said viewer.

40. A system for conducting e-commerce over a transaction-enabled broadcast network, said system comprising:
a broadcast receiving device operatively coupled to said network and configurable to enable a viewer to interact with an interactive broadcast; and
a local network operator operatively coupled to said network, said local network operator comprising a controller, said controller operatively configurable to tabulate data based on commerce activities conducted by a viewer on said network.

41. A method of conducting e-commerce over a transaction-enabled broadcast network, said method comprising:
creating an advertisement comprising non-interactive content, said advertisement being broadcast over said network; and
creating interactive content, said additional content being selectively integrated with said non-interactive content according to a predetermined schedule.

42. The method of claim 41 wherein said integrated content is selectively integrated using a controller.

43. The method of claim 41 wherein said predetermined schedule is allocated into time slots.

44. The method of claim 43 wherein said time slots are purchased by an advertiser from a network operator.

45. The method of claim 41 wherein said integrated content is broadcast to a predetermined local market.

46. A method of conducting e-commerce over a transaction-enabled broadcast network, said method comprising:
creating broadcast content comprising conventional content and interactive advertising content for broadcast over said network; and
selectively broadcasting said interactive content by way of a controller according to a pre-specified agreement.

47. The method of claim 46 wherein said agreement is made between an advertiser and network operator.

48. A method of conducting e-commerce over a transaction-enabled broadcast network, said method comprising:
creating broadcast content comprising conventional and interactive advertising content;
broadcasting said broadcast content;
receiving request data over said network from a viewer, said request data being transmitted by said viewer in response to said broadcast content; and
routing said request data to a local server for fulfillment.

49. An article of manufacture for coordinating interactive television offerings over a transaction enabled broadcast network, the article comprising a machine readable medium containing one or more programs which when executed implement the steps of:
receiving broadcast content from a broadcast content source;
processing the broadcast content;
transmitting said processed broadcast content over said network to a viewer;
receiving request data over said network from said viewer, said data being transmitted by said viewer in response to said processed broadcast content; and
processing said request data.
